(19) United States
(12) Patent Application Publication
(10) Pub. No.: US 2009/0286083 A1
(43) Pub. Date: Nov. 19, 2009

(54) Copper wire for a magnet wire, magnet wire using same, and method for fabricating copper wire for a magnet wire

(75) Inventors: Shinichi Kudo, Hitachi (JP); Hidenori Abe, Hitachi (JP); Hidetoshi Nagayama, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: Hitachi Cable, Ltd., Tokyo (JP); Hitachi Wire and Rod, Ltd., Ibaraki (JP); Hitachi Magnet Wire Corp., Ibaraki (JP)

(21) Appl. No.: 12/318,687

(22) Filed: Jan. 6, 2009

(30) Foreign Application Priority Data
May 13, 2008 (JP) 2008-125714

(51) Int. Cl. B32B 15/02; C22C 9/00; B22D 11/01

(52) U.S. Cl. 428/379; 148/432; 164/462

(57) ABSTRACT

A copper wire for a magnet wire, a magnet wire using same, and a method for fabricating the copper wire for the magnet wire. The copper wire for the magnet wire is made from a casting material. The casting material is fabricated by continuous upward drawing from a molten copper or a molten copper alloy. An average crystal grain diameter of a columnar crystal structure formed at a surface layer of the casting material is 200 to 300 μm. An upward drawing rate is 4 m/min to 5 m/min and a temperature of the molten copper or the molten copper is 1100 to 1200° C.

The present application is based on Japanese Patent Application No. 2008-125714 filed on May 13, 2008, the entire contents of which are incorporated herein by reference.

### BACKGROUND OF THE INVENTION

1. Field of the Invention

The present invention relates to a copper wire for a magnet wire, a magnet wire using the same, and a method for fabricating a copper wire for a magnet wire, more particularly, to a copper wire for a magnet wire, a magnet wire using the same, and a method for fabricating a copper wire for a magnet wire that are suitable for a high efficiency motor.

2. Related Art

A copper wire (copper for a wire) which is suitable for a magnet wire is a copper wire rod that is fabricated by rolling a copper ingot and the like. Such a copper wire is processed to provide a wire with a predetermined dimension (such as circular wire, rectangular wire) then coated with resin coating, so as to provide a magnet wire and the like.

In recent years, there is requirement of an oxygen-free copper in which voids due to gas hardly occur at the time of connection welding of the magnet wire. For satisfying this requirement, the oxygen-free copper wire in which the gas void does not occur at the time of the connection welding has been used as the magnet wire.

As methods for fabricating the oxygen-free copper, there is a so-called “dip forming” method in which an oxygen-free molten copper is continuously solidified at an outer periphery of a core rod (of oxygen-free copper), or an upward drawing continuous casting method (so-called “up-casting” method) in which a molten copper is solidified in a cast disposed at a molten copper surface and continuously drawn upwardly.

However, there is a disadvantage in the dip forming method which is one of the methods for fabricating the oxygen-free copper wire that a fabricating process is complicated. It is possible to fabricate the copper wire with less cost by using the upward drawing continuous casting method (up-casting method) compared with the dip forming method.

Japanese Patent Laid-Open No. 2005-313208 (JP-A-2005-313208) and Japanese Patent Laid-Open No. 11-010220 (JP-A-11-010220) disclose the conventional methods for fabricating the copper wire.

There are micro defects such as cracks at a surface of the oxygen-free copper wire. Such micro defects still remain at the time of processing into a magnet wire conductor (such as circular wire, rectangular wire), thereby causing defects such as blister in a resin coating layer at a baking process after the resin coating process.

Particularly in a rectangular wire, there is a problem in that the micro defects remaining in a direction perpendicular to a rolling direction axis are easily magnified, due to a tensile stress applied thereto. In addition, since the resin is not coated with a uniform thickness at edges of the rectangular wire, there is a problem in that the defect such as the blister is easily generated.

For solving the above problems, following solutions are proposed.

JP-A-2005-313208 discloses a copper wire for a magnet wire and a method for fabricating the same. JP-A-2005-313208 describes that the micro defects of the oxygen-free copper wire are caused by a coarse blow hole included in the copper ingot. The blow hole in the copper ingot, which causes the blister and the like in the resin coating layer after the resin coating process, is made harmless, by reducing an inner diameter of the blow hole included in the copper ingot for the copper wire for a magnet wire to be 3.0 mm or less, and by performing a light-reduction rolling on the copper ingot at a rolling reduction of 3 to 20% at a temperature of 800 to 900° C. before continuous rolling of the copper ingot.

However, as shown in JP-A-11-010220, in the conventional method for fabricating a copper wire (wire rod) for a magnet wire using the continuous casting rolling method or the continuous casting method, a peeling process is usually performed as a post-process, so as to remove a cracking defect generated during the rolling and to remove an oxide film irregularly wedged.

In this point, the machinability such as the peeling of the oxygen-free copper wire is remarkably low compared with that of a tough-pitch copper. Therefore, when the peeling process is performed, the peeling may newly cause defects such as laps. Accordingly, it is possible to perform small-amount cutting or multiple-time cutting in the peeling process. However, it is assumed that the productivity will be deteriorated if the small-amount cutting or the multiple-time cutting is performed.

As described above, it is impossible to suppress the defect such as blister in the resin coating layer in the baking process alter the resin coating process only by suppressing the defect such as crack at the surface of an initial oxygen-free copper wire, even though the peeling process is performed as the post-process. In other words, it is difficult to suppress the blisters without solving problem of all micro defects occurred in the fabricating process (particularly the defects such as laps due to insufficient cutting such as the peeling in the post-process).

In recent years, a polyamideimide system resin is particularly employed as a resin material. There is a problem in that the defect such as blister is easily generated, because of carbon dioxide generated in a reaction process at the time of baking the polyamideimide system resin.

The peeling property of the oxygen-free copper wire in the peeling process is greatly varied in accordance with the fabrication method (the continuous casting rolling method, the dip forming method, the up-casting method). Therefore, there is a problem in that it is difficult to provide a stable quality when a specific peeling condition is applied to the oxygen-free copper wires fabricated by different fabrication methods. In particular, when the specific peeling condition is applied to the oxygen-free copper wire fabricated by the up-casting method, it is difficult to provide the stable quality compared with those fabricated by the other conventional fabrication methods.

The prior arts described above intended to reduce the defects at the conductor surface which causes the defect such as blister in the resin coating layer in the baking process after the resin coating process, by making the micro defects originally existing at the surface of the wire rod for a copper wire harmless. However, according to the fabrication methods disclosed in the prior arts, it is difficult to reduce the defects newly generated at the time of the cutting such as peeling.

### SUMMARY OF THE INVENTION

Accordingly, the object of the present invention is to provide a copper wire for a magnet wire, a magnet wire using the same, and a method for fabricating a copper wire for a magnet wire with an excellent peeling property, so as to suppress the defect such as blister in the resin coating layer in the baking process after the resin coating process.

According to a feature of the invention, a copper wire for a magnet wire, comprises:

a casting material fabricated by continuous upward drawing from a molten copper or a molten copper alloy,

in which an average crystal grain diameter of a columnar crystal structure formed at a surface layer of the casting material is 200 to 300 μm.

In the copper wire for the magnet wire, the casting material may comprise an oxygen-free copper wire containing an oxygen of not greater than 10 ppm (0.001 mass %).

In the copper wire for the magnet wire, the casting material may be processed to have a rectangular cross section.

According to another feature of the invention, a magnet wire comprises:

a copper wire comprising a casting material fabricated by continuous upward drawing from a molten copper or a molten copper alloy; and

a resin coating provided at an outer periphery of the copper wire,

in which an average crystal grain diameter of a columnar crystal structure formed at a surface layer of the casting material is 200 to 300 μm.

In the magnet wire, the casting material may comprise an oxygen-free copper wire containing an oxygen of not greater than 10 ppm ( 0.001 mass %).

In the magnet wire, the casting material may be processed to have a rectangular cross section.

In the magnet wire, the resin coating may have a triple layer structure comprising a high adhesion polyamideimide layer, a polyimide layer, and a polyamideimide layer.

In the magnet wire, the resin coating may have a double layer structure comprising a high adhesion polyimide layer and a polyamideimide layer.

According to a still another feature of the invention, a method for fabricating a copper wire for a magnet wire comprises:

forming a casting material by continuously drawing upward from a molten copper or a molten copper alloy,

wherein a upward drawing rate is 4 m/min to 5 m/min and a temperature of the molten copper or the molten copper is 1100 to 1200° C.

The method for fabricating the copper wire for the magnet wire may further comprise:

performing a peeling process on the casting material; and

annealing the casting material after the peeling process.

In the method for fabricating the copper wire for the magnet wire, the casting material may comprise an oxygen-free copper wire containing an oxygen of not greater than 10 ppm (0.001 mass %).

The method for fabricating the copper wire for the magnet wire may further comprise:

processing the casting material to have a rectangular cross section.

### ADVANTAGES OF THE INVENTION

According to the present invention, it is possible to suppress the defects such as blister of the resin when the copper wire for a magnet wire is coated with the resin and baked to provide the magnet wire.

### BRIEF DESCRIPTION OF THE DRAWINGS

Next, a preferred embodiment according to the present invention will be described in conjunction with appended drawings, wherein:

FIG. 1 is a schematic diagram showing a vertical cross sectional structure of a surface layer of a copper wire for a magnet wire in a longitudinal direction in a preferred embodiment according to the present invention;

FIGS. 2A and 2B are schematic diagrams showing the copper wire for a magnet wire in the preferred embodiment according to the present invention, wherein FIG. 2A is a cross sectional view of a circular wire in the preferred embodiment according to the present invention, and FIG. 2B is a cross sectional view of a rectangular wire in the preferred embodiment according to the present invention; and

FIG. 3 is a schematic diagram of an oxygen-free copper wire fabricating apparatus for fabricating a copper wire for a magnet wire shown in FIG. 1.

### DETAILED DESCRIPTION OF PREFERRED EMBODIMENT

Next, a copper wire for a magnet wire, a magnet wire using the same, and a method for fabricating a copper wire for a magnet wire in the preferred embodiment according to the present invention will be explained in more detail in conjunction with the appended drawings.

First of all, the Inventors of the present invention studied the peeling property of copper for a wire (oxygen-free copper) fabricated by the up-casting method, and found that difference in the peeling-property depends on size of a crystal grain size of the copper for a wire. The copper or the copper alloy casting material cast by the up-casting method comprises a columnar crystal structure which extends from a surface of a wire member to an inside of the wire member, so that the crystal grain has an elongated shape.

### (Copper Wire for a Magnet Wire)

FIG. 1 is a schematic diagram showing a vertical cross sectional structure of a surface layer of a copper wire for a magnet wire in a longitudinal direction in a preferred embodiment according to the present invention.

As shown in FIG. 1, a copper wire 1 for a magnet wire has a surface layer 2, and the surface layer 2 comprises a columnar crystal structure 3.

The inventors remarked an average value of respective lengths d of the crystal grains at the wire member surface in a longitudinal direction of the wire member, namely a crystal grain size (average crystal grain diameter) as shown in FIG. 1.

Finally, the Inventors found that the number of crystal grain boundaries which serves as a start point for cutting is increased in accordance with reduction in the crystal grain size at the time of peeling the oxygen-free copper wire. According to this structure, a continuous shearing is facilitated, so that the machinability such as the peeling is improved. As a result, it is possible to remove the micro defects originally existing in the wire rod such as the cracks without generating new defects at the wire member surface, thereby suppressing the defect such as the blister of the resin.

In addition, the Inventors found that it is possible to provide the excellent peeling property when the crystal grain size of the columnar crystal structure 3 at the surface layer 2 of the copper wire 1 for a magnet wire is 200 to 300 μm. As a result of zealous examinations, it is confirmed that the crystal grain size can be controlled by controlling a rate (speed) of drawing the casting material upwardly from the molten metal.

### (Method for Fabricating the Copper Wire for a Magnet Wire)

Next, a method for fabricating the copper wire 1 for a magnet wire will be explained below.

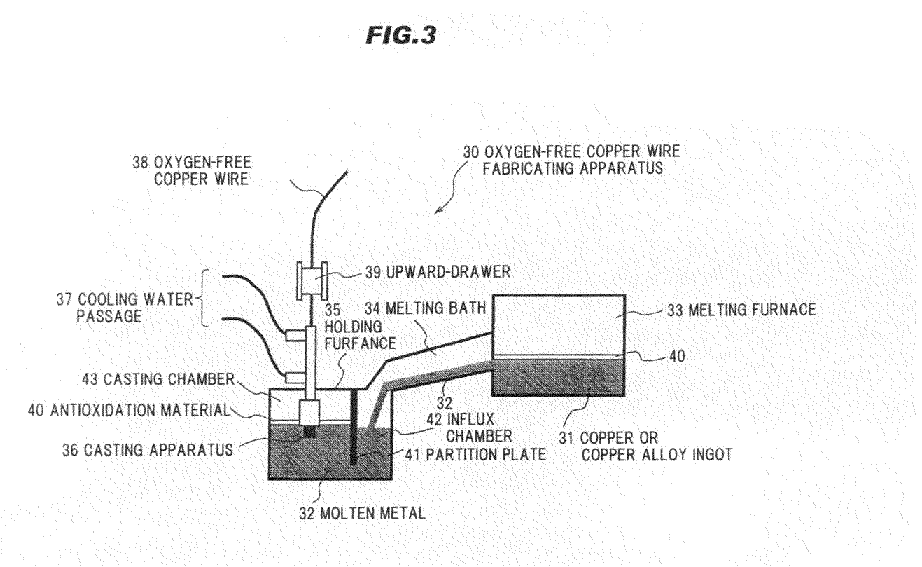

FIG. 3 is a schematic diagram of an oxygen-free copper wire fabricating apparatus for fabricating the copper wire 1 for a magnet wire shown in FIG. 1.

As shown in FIG. 3, the oxygen-free copper wire fabricating apparatus 30 for fabricating the copper wire 1 for a magnet wire is adopted for the upward drawing continuous casting method (up-casting method). The oxygen-free copper wire fabricating apparatus 30 comprises a melting furnace 33 in which a copper or copper alloy ingot 31 is molten to provide a molten metal (molten copper or molten copper alloy) 32, a melting bath 34 through which the copper or copper alloy ingot 31 molten in the melting furnace 33 is flown, a holding furnace 35 in which the molten metal 32 of the copper or copper alloy ingot 31 is held at a molten state, a casting apparatus 36 disposed at a molten metal surface of the holding furnace 35 in which a casting material is cast from the molten metal 32, a cooling water passage 37 for supplying a cooling water by which the casting material cast in the casting apparatus 36 is cooled and solidified, and an upward-drawer 39 for continuously drawing upward an oxygen-free copper wire 38 made by solidifying the casting material.

In the melting furnace 33 and the holding furnace 35, the copper or copper alloy ingot 31 and the molten metal 32 are sealed up with an antioxidation material 40 inside the furnaces, so as to fabricate the oxygen-free copper wire containing oxygen of not greater than 10 ppm (0.001 mass %).

In the holding furnace 35, a partition plate 41 extending from an upper part of the furnace to a part below the molten metal surface is disposed. The holding furnace 35 is sectioned by the partition plate 41 into an influx chamber 42 to which the molten metal 32 is supplied, and a casting chamber 43 communicated with the influx chamber 42 under the partition plate 41, in which the casting apparatus 36 is provided.

The molten metal 32 supplied into the influx chamber 42 flows into the casting chamber 43 by passing under the partition plate 41. The casting chamber 43 is sealed up by the antioxidation material 40. In addition, the holding furnace 35 is an electric furnace, and controlled to keep a temperature of the molten metal 32 constant.

The copper wire 1 for a magnet wire shown in FIG. 1 is fabricated by continuously drawing upward the casting material at a rate of 4 m/min to 5 m/min from the molten copper or molten copper alloy 32 at a temperature of 1100 to 1200° C. in the casting material forming process. When fabricating a magnet wire by annealing and resin-coating the copper wire 1 for a magnet wire after the peeling process, the magnet wire may be processed to have circular shape or rectangular shape.

The temperature of the molten copper or molten copper alloy is determined to be 1100 to 1200° C., since the copper and the copper alloy are molten within this temperature range.

The rate of drawing upward the casting material is determined to be 4 m/min to 5 m/min, since it is possible to control the average crystal grain diameter of the columnar crystal structure 3 formed in the surface layer 2 of the oxygen-free copper wire 1 by controlling an initial cooling at the time of casting the casting material. Namely, it is possible to provide the copper wire 1 for a magnet wire with the average crystal grain diameter of 200 to 300 μm, by determining the drawing rate within this range.

According to the method for fabricating the copper wire 1 for a magnet wire, it is possible to suppress the defects such as the blister of the resin when the magnet wire is fabricated by resin-coating and baking the copper wire for a magnet wire 1. Further, since the complicated process and equipment are not required, the copper wire 1 for a magnet wire fabricated by the up-casting method is not expensive.

### (Magnet Wire)

Next, magnet wires 20 and 21 each using the copper wire 1 for a magnet wire will be explained below.

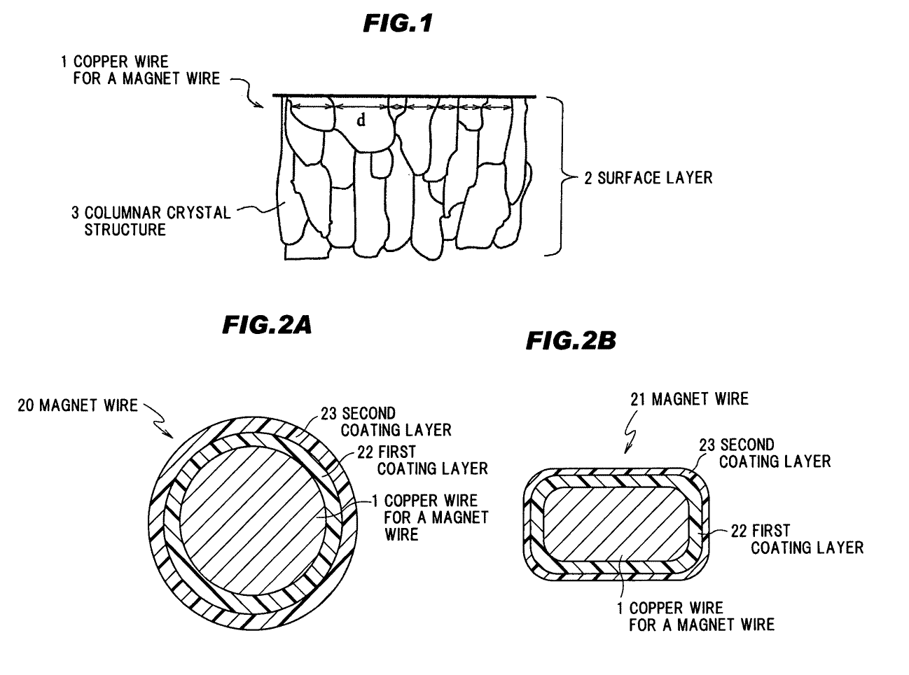

FIGS. 2A and 2B are schematic diagrams showing the copper wire for a magnet wire in the preferred embodiment according to the present invention, in which FIG. 2A is a cross sectional view of a circular wire in the preferred embodiment according to the present invention, and FIG. 2B is a cross sectional view of a rectangular wire in the preferred embodiment according to the present invention.

As shown in FIG. 2A, a magnet wire 20 having a circular cross section comprises a copper wire 1 for a magnet wire shown in FIG. 1, a first coating layer 22 comprising a resin and formed at an outer periphery of the copper wire 1, and a second coating layer 23 comprising a resin and formed at an outer periphery of the first coating layer 22.

Similarly, as shown in FIG. 2B, a magnet wire 21 having a rectangular cross section comprises a copper wire 1 for a magnet wire shown in FIG. 1, a first coating layer 22 comprising a resin and formed at an outer periphery of the copper wire 1, and a second coating layer 23 comprising a resin and formed at an outer periphery of the first coating layer 22.

The first coating layer 22 preferably comprises a high adhesion polyimide, and the second coating layer 23 preferably comprises a polyamideimide.

Further, a coating layer of the copper wire 1 for a magnet wire may have a triple layer structure comprising a high adhesion polyamideimide layer, a polyimide layer, and a polyamideimide layer.

According to the magnet wires 20 and 21, it is possible to reduce the defects such as the blister of the resin coating layer by using the copper wire 1 for a magnet wire with the excellent peeling property.

### EXAMPLES

### Example 1

An oxygen-free copper wire rod was fabricated by continuously drawing upward the casting material at a rate of 5.0 m/min from a molten copper alloy at a temperature of 1150° C. by using the upward drawing continuous casting method (up-casting method). The oxygen-free copper wire rod has a wire diameter of 8 mm and an average crystal grain diameter (crystal grain size) at a wire rod surface of 200 μm.

The drawing process was performed on the oxygen-free copper wire rod with a processing degree of 30%, and the peeling process was performed on the drawn oxygen-free copper wire rod to peel a layer having a thickness of 0.15 mm from a surface in a depth direction with respect to a material circumferential direction. For the peeling processing, a peeling die with a rake angle of 30° was used. In addition, the peeling rate was 200 m/min.

After the peeling process, the copper wire drawn to have a wire diameter of 2.6 mm was annealed. Thereafter, a rectangular processing (i.e. processing for providing a rectangular cross section) was performed on the copper wire and the copper wire was annealed. Finally, the copper wire was coated with a resin and baked to provide a magnet wire. The resin coating has a double layer structure comprising a high adhesion polyimide layer and a polyamideimide layer.

### Example 2

An oxygen-free copper wire rod was fabricated by continuously drawing upward the casting material at a rate of 4.5 m/min from a molten copper alloy at a temperature of 1150° C. by using the upward drawing continuous casting method (up-casting method). The oxygen-free copper wire rod has a wire diameter of 8 mm and an average crystal grain diameter (crystal grain size) at a wire rod surface of 250 μm.

The drawing process was performed on the oxygen-free copper wire rod with a processing degree of 30%, and the peeling process was performed on the drawn oxygen-free copper wire rod to peel a layer having a thickness of 0.15 mm from a surface in a depth direction with respect to a material circumferential direction. For the peeling processing, a peeling die with a rake angle of 30° was used. In addition, the peeling rate was 200 m/min.

After the peeling process, the copper wire drawn to have a wire diameter of 2.6 mm was annealed. Thereafter, a rectangular processing (i.e. processing for providing a rectangular cross section) was performed on the copper wire and the copper wire was annealed. Finally, the copper wire was coated with a resin and baked to provide a magnet wire. The resin coating has a double layer structure comprising a high adhesion polyimide layer and a polyamideimide layer.

### Example 3

An oxygen-free copper wire rod was fabricated by continuously drawing upward the casting material at a rate of 4.0 m/min from a molten copper alloy at a temperature of 1150° C. by using the upward drawing continuous casting method (up-casting method). The oxygen-free copper wire rod has a wire diameter of 8 mm and an average crystal grain diameter (crystal grain size) at a wire rod surface of 300 μm.

The drawing process was performed on the oxygen-free copper wire rod with a processing degree of 30%, and the peeling process was performed on the drawn oxygen-free copper wire rod to peel a layer having a thickness of 0.15 mm from a surface in a depth direction with respect to a material circumferential direction. For the peeling processing, a peeling die with a rake angle of 30° was used. In addition, the peeling rate was 200 m/min.

After the peeling process, the copper wire drawn to have a wire diameter of 2.6 mm was annealed. Thereafter, a rectangular processing (i.e. processing for providing a rectangular cross section) was performed on the copper wire and the copper wire was annealed. Finally, the copper wire was coated with a resin and baked to provide a magnet wire. The resin coating has a double layer structure comprising a high adhesion polyimide layer and a polyamideimide layer.

### Comparative Example 1

An oxygen-free copper wire rod was fabricated by continuously drawing upward the casting material at a rate of 3.0 m/min from a molten copper alloy at a temperature of 1150° C. by using the upward drawing continuous casting method (up-casting method). The oxygen-free copper wire rod has a wire diameter of 8 mm and an average crystal grain diameter (crystal grain size) at a wire rod surface of 400 μm.

The drawing process was performed on the oxygen-free copper wire rod with a processing degree of 30%, and the peeling process was performed on the drawn oxygen-free copper wire rod to peel a layer having a thickness of 0.15 mm from a surface in a depth direction with respect to a material circumferential direction. For the peeling processing, a peeling die with a rake angle of 30° was used. In addition, the peeling rate was 200 m/min.

After the peeling process, the copper wire drawn to have a wire diameter of 2.6 mm was annealed. Thereafter, a rectangular processing (i.e. processing for providing a rectangular cross section) was performed on the copper wire and the copper wire was annealed. Finally, the copper wire was coated with a resin and baked to provide a magnet wire. The resin coating has a double layer structure comprising a high adhesion polyimide layer and a polyamideimide layer.

### Comparative Example 2

An oxygen-free copper wire rod was fabricated by continuously drawing upward the casting material at a rate of 2.5 m/min from a molten copper alloy at a temperature of 1150° C. by using the upward drawing continuous casting method (up-casting method). The oxygen-free copper wire rod has a wire diameter of 8 mm and an average crystal grain diameter (crystal grain size) at a wire rod surface of 500 μm.

The drawing process was performed on the oxygen-free copper wire rod with a processing degree of 30%, and the peeling process was performed on the drawn oxygen-free copper wire rod to peel a layer having a thickness of 0.15 mm from a surface in a depth direction with respect to a material circumferential direction. For the peeling processing, a peeling die with a rake angle of 30° was used. In addition, the peeling rate was 200 m/min.

After the peeling process, the copper wire drawn to have a wire diameter of 2.6 mm was annealed. Thereafter, a rectangular processing (i.e. processing for providing a rectangular cross section) was performed on the copper wire and the copper wire was annealed. Finally, the copper wire was coated with a resin and baked to provide a magnet wire. The resin coating has a double layer structure comprising a high adhesion polyimide layer and a polyamideimide layer.

The average crystal grain diameter (crystal grain size) was controlled by changing a processing rate of the drawing apparatus (drawing rate). Further, the holding furnace is an electric furnace, and the temperature of the molten copper alloy was controlled to be constant. The temperature was measured by inserting a thermocouple into the holding furnace.

TABLE 1 shows a blister generation rate in the respective magnet wires in the Examples 1 to 3 and the Comparative examples 1 and 2, and total evaluation thereof. When the blister generation rate is less than 0.30 pieces/km, the total evaluation is “good” (⊚). When the blister generation rate is not less than 0.30 pieces/km, the total evaluation is “bad” (×).

TABLE 1

| | The average crystal grain | | |
|---|---|---|---|
| | diameter (crystal grain | The blister | |
| | size) of the oxygen-free | generation rate in | |
| | copper wire | the magnet wire | Total |
| Examples | (μm) | (pieces/km) | evaluation |
| Example 1 | 200 | 0.25 | ⊚ |
| Example 2 | 250 | 0.25 | ⊚ |
| Example 3 | 300 | 0.30 | ⊚ |
| Comparative | 400 | 20.0 | X |
| example 1 | | | |
| Comparative | 500 | 25.0 | X |
| example 2 | | | |

As shown in TABLE 1, the peeling process was performed on the oxygen-free copper wire rod having the wire diameter of 8 mm (φ8 WR) fabricated by the up-casting method in the Examples 1 to 3. In the Examples 1 to 3, the peeling property was good. Since the micro defects such as the cracks originally existing in the wire rod were removed without causing new defects on the wire member, the blister generation rate in the magnet wire was remarkably reduced. The total evaluation of the Examples 1 to 3 was good.

Similarly, the peeling process was performed on the oxygen-free copper wire rod having the wire diameter of 8 mm (φ8 WR) fabricated by the up-casting method in the Comparative examples 1 and 2. However, in the Comparative example 1 and 2, the crystal grain size at the surface layer of the wire member was greater than those in the Examples 1 to 3, so that the crystal grain boundaries serving as the starting point for cutting are less than those in the Examples 1 to 3. Therefore, variation of resistance in the cutting process is large so that the continuous shearing deformation is difficult, thereby deteriorating the peeling property. As a result, the new defect occurs in the wire member surface, and the micro defects such as the crack originally existing in the wire rod cannot be removed, so that the blister generation rate in the magnet wire is increased compared with those in the Examples 1 to 3.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

1. A copper wire for a magnet wire, comprising:
a casting material fabricated by continuous upward drawing from a molten copper or a molten copper alloy,
wherein an average crystal grain diameter of a columnar crystal structure formed at a surface layer of the casting material is 200 to 300 μm.

2. The copper wire for the magnet wire according to claim 1, wherein the casting material comprises an oxygen-free copper wire containing an oxygen of not greater than 10 ppm (0.001 mass %).

3. The copper wire for the magnet wire according to claim 1, wherein the casting material is processed to have a rectangular cross section.

4. A magnet wire comprising:
a copper wire comprising a casting material fabricated by continuous upward drawing from a molten copper or a molten copper alloy; and
a resin coating provided at an outer periphery of the copper wire,
wherein an average crystal grain diameter of a columnar crystal structure formed at a surface layer of the casting material is 200 to 300 μm.

5. The magnet wire according to claim 4, wherein the casting material comprises an oxygen-free copper wire containing an oxygen of not greater than 10 ppm (0.001 mass %).

6. The magnet wire according to claim 4, wherein the casting material is processed to have a rectangular cross section.

7. The magnet wire according to claim 4, wherein the resin coating has a triple layer structure comprising a high adhesion polyamideimide layer, a polyimide layer, and a polyamideimide layer.

8. The magnet wire according to claim 4, wherein the resin coating has a double layer structure comprising a high adhesion polyimide layer and a polyamideimide layer.

9. A method for fabricating a copper wire for a magnet wire, comprising:
forming a casting material by continuously drawing upward from a molten copper or a molten copper alloy,
wherein a upward drawing rate is 4 m/min to 5 m/min and a temperature of the molten copper or the molten copper is 1100 to 1200° C.

10. The method for fabricating the copper wire for the magnet wire according to claim 9, further comprising:
performing a peeling process on the casting material; and
annealing the casting material after the peeling process.

11. The method for fabricating the copper wire for the magnet wire according to claim 10, wherein the casting material comprises an oxygen-free copper wire containing an oxygen of not greater than 10 ppm (0.001 mass %).

12. The method for fabricating the copper wire for the magnet wire according to claim 10, further comprising:
processing the casting material to have a rectangular cross section.
